(19) United States
(12) Patent Application Publication
(10) Pub. No.: US 2024/0287369 A1
(43) Pub. Date: Aug. 29, 2024

(54) PHASE CHANGE MATERIALS

(71) Applicant: PETROLIAM NASIONAL BERHAD (PETRONAS), Kuala Lumpur (MY)

(72) Inventors: Andrea DOLFI, Kuala Lumpur (MY); Giuseppe TRAVAGLINI, Kuala Lumpur (MY)

(21) Appl. No.: 18/571,044

(22) PCT Filed: Jun. 16, 2022
(86) PCT No.: PCT/MY2022/050050

§ 371 Date: Dec. 15, 2023

(30) Foreign Application Priority Data
Jun. 17, 2021 (MY) PI2021003417

(51) Int. Cl. C09K 5/06; F28D 20/02

(52) U.S. Cl. CPC C09K 5/063; F28D 20/02

(57) ABSTRACT

Disclosed herein is a phase change material composition comprising a fatty alcohol, which has from 10 to 30 carbon atoms, that is able to store and to release thermal energy.

### FIELD OF INVENTION

The current invention relates to a phase change material composition comprising a fatty alcohol and a product incorporating the phase change material compositions.

### BACKGROUND

The listing or discussion of a prior-published document in this specification should not necessarily be taken as an acknowledgement that the document is part of the state of the art or is common general knowledge.

Phase change materials (PCMs) are substances which absorb or release large amounts of “latent” heat when they change phase or state, i.e., from solid to liquid and vice versa. They can be used for regulating temperature and improving heat insulation. As such they find applications in packaging, clothing, goods delivery and insulating materials.

Organic PCMs generally refers to paraffin wax or non-paraffin PCMs. Their main advantages are the good latent heat storing ability, no supercooling and overall good compatibility with plastics and metals compared to the other PCMs. However, they are often a mixture of paraffins with low purity grade-which cannot absorb heat at a specific temperature. Synthetic paraffins are uncommon and can be expensive.

Non-paraffin PCMs include general fatty acids and esters. They can be produced from renewable sources, and similar to paraffin waves, have good latent heat storing ability and low supercooling. They also typically have a higher flash point compared to other organic chemicals, hence they are less of a fire risk. However, they suffer from compatibility problems with some materials and from issues of oxidation over time. In addition, high purity esters can be very expensive.

Inorganic PCMs generally refer to hydrated salts. They offer a wide range of melting temperatures, with good heat storing ability and the advantage of not being flammable. However, they are less durable than organics as overtime the water tend to segregate. The presence of supercooling and issues of compatibility with materials that are commonly used for tanks also presents problems for real applications.

PCMs may be applied as a regulating temperature media in thermal batteries for domestic water and for heating, ventilation and air conditioning (HVAC) systems. For example, but not limited to, residential buildings, in which they offer the possibility of optimizing the energy consumption to maintain a comfortable room temperature. In such application, thermal energy provided by an external supply system (e.g. a district heating system, boilers or solar collectors) is stored by a PCM based thermal energy storage system (i.e. thermal battery), during periods of maximum power availability and released during periods of maximum power demand. For example, when the thermal energy is supplied by solar collectors, PCMs may enhance the efficiency by storing energy during the day and release energy when the solar radiation is not available at night.

As such, there is a need for improved PCMs that address one or more issues mentioned above.

### SUMMARY OF INVENTION

The invention relates to a phase change material and a product comprising the phase change material. Aspects and embodiments of the invention are described in the following clauses.

1. A phase change material composition comprising a fatty alcohol, which has from 10 to 30 carbon atoms, that is able to store and to release thermal energy.

2. The composition according to Clause 1, wherein the fatty alcohol is a saturated linear fatty alcohol having 10 to 26 carbon atoms, such as from 16 to 26 carbon atoms (such as from 20 to 24 carbon atoms, such as 22 carbon atoms).

3. The composition according to Clause 2, wherein the fatty alcohol is selected from one or more of the group consisting of 1-decanol, 1-dodecanol, 1-tridecanol, 1-tetradecanol, 1-pentadecanol, 1-hexadecanol, 1-octadecanol and 1-docosanol (e.g. the saturated linear fatty alcohol is selected from one or more of the group consisting of 1-hexdecanol, 1-octadecanol and 1-docosanol).

4. The composition according to Clause 3, wherein the fatty alcohol is 1-docosanol.

5 The composition according to any one of the preceding Clauses, wherein the composition has a melting point of from 4 to 85° C., such as from 5 to 80° C., such as from 6 to 75° C., such as 70° C.

6. The composition according to any one of the preceding Clauses, wherein the composition has a latent heat of fusion of from 100 to 400 J/g such as from 180 to 300 J/g, such as 291 J/g.

7. The composition according to any one of the preceding Clauses, wherein the composition comprises a further component selected from a nucleating agent, a thermal stabiliser, an anti-oxidant, a metal deactivator, a corrosion inhibitor, a fire-retardant, a structuring agent, a fatty acid, a thermal conductivity enhancer and mixtures thereof.

8 The composition according to Clause 7, wherein the further component is selected from an anti-oxidant, a structuring agent, a flame retardant and mixtures thereof.

9. The composition according to any one of Clauses 7 to 8, wherein the further component is present in an amount of from 0.01 to 10 wt % (e.g. from 0.1 to 5 wt %).

10. A phase change material product comprising a container and a phase change material composition according to any one of Clauses 1 to 10 housed within the container.

11 The product according to Clause 10, wherein the product further comprises a heat exchanger.

12. The product according to Clause 11, wherein the heat exchanger is a plate heat exchanger or a spiral heat exchanger.

13. A product or system comprising the phase change material product according to any one of Clauses 10 to 12, optionally wherein the product or system is selected from a textile, a foam, a medical device, an electronic product, a packaging material, a construction material, a refrigeration system, a water heating system, and a heating, ventilation, air-conditioning (HVAC) system, optionally wherein the product or system is a water heating system (e.g. a domestic water heating system) or a heating, ventilation, air-conditioning (HVAC) system.

14. A method of regulating temperature in an environment comprising the steps of:
(a) providing in the environment an amount of a phase change material composition according to any one of Clauses 1 to 9; and
(b) storing and releasing thermal energy in the phase change material composition by transfer of thermal energy between the environment and the phase change material composition, such that the temperature of the environment is regulated over a period of time.

15. The method according to Clause 14, wherein the transfer of thermal energy between the environment and the phase change material composition is used in the temperature regulation of sanitary water and/or in heating, ventilation and air-conditioning (HVAC) systems.

16. The method according to any one of Clauses 14 to 15, wherein the period of time is from 1 minute to 7 days, such as from 5 minutes to 3 days, such as from 10 minutes to 1 hour (e.g. 20 minutes)

17. The method according to any one of Clauses 14 to 16, wherein the transfer of thermal energy between the environment and the phase change material composition is used in the temperature regulation of a heat or cold sensitive material located within the environment.

18. The method according to Clause 17, wherein the heat or cold sensitive material is water.

19. Use of a fatty alcohol that has from 10 and 30 carbon atoms as a temperature regulating media for sanitary water and/or for heating, ventilation and air conditioning (HVAC) systems.

### BRIEF DESCRIPTION OF DRAWINGS

FIG. 1 depicts a DSC analysis of A) docosanol and B) a commercial PCM.

### DESCRIPTION

It has been surprisingly found that certain fatty alcohols are particularly good phase change materials (PCMs), more particularly for use in thermal exchange systems such as thermal batteries.

In a first aspect of the invention, there is provided a phase change material composition comprising a fatty alcohol, which has from 10 to 30 carbon atoms, that is able to store and to release thermal energy.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. Generally, a higher purity for the fatty alcohol leads to better phase change performance. Purity may affect the melting temperature and heat storage ability, and as such, the phase changing behavior. As such, the material may be greater than or equal to 85% pure, such as greater than 90% pure, such as greater than 95% pure, such as greater than 98% pure, such as greater than 99% pure, such as greater than 99.9% pure, such as greater than 99.99% pure, such as 100% pure.

When used herein, the term “fatty alcohol”, unless otherwise specified, refers to a range of aliphatic hydrocarbons containing a hydroxyl group. The hydroxyl group may be present in the terminal position (i.e. bonded to the first carbon of the fatty alcohol) or at any position other than the first carbon. The alkyl portion of the fatty alcohol may be linear or branched. The alkyl portion of the fatty alcohol may be saturated or unsaturated.

Various preferred embodiments of the invention are described below.

The total number of carbon atoms in the fatty alcohol is from 10 to 30 carbon atoms. The total number of carbons in the fatty alcohol may be an even number or an odd number.

In some embodiments of the invention, the fatty alcohol is a linear saturated fatty alcohol. In line with “fatty alcohol” as described above, the term “linear saturated fatty alcohol” means that the alkyl portion of the fatty alcohol is linear and saturated.

In some embodiments of the invention, the fatty alcohol is a linear saturated fatty alcohol having 10 to 26 carbon atoms, such as from 16 to 26 carbon atoms (such as from 20 to 24 carbon atoms, such as 22 carbon atoms).

In some embodiments of the invention, the fatty alcohol is selected from one or more of the group consisting of 1-decanol, 1-dodecanol, 1-tridecanol, 1-tetradecanol, 1-pentadecanol, 1-hexadecanol, 1-octadecanol and 1-docosanol (e.g. the saturated linear fatty alcohol is selected from one or more of the group consisting of 1-hexdecanol, 1-octadecanol and 1-docosanol).

In some particular embodiments of the invention, the fatty alcohol is 1-docosanol.

The phase change composition may be useful for HVAC systems and domestic water heating systems. As such, in some embodiments of the invention, the composition has a melting point of from 4 to 85° C., such as from 5 to 80° C., such as from 6 to 75° C., such as 70° C. The melting point may be measured by differential scanning calorimetry (DSC).

A higher latent heat of fusion generally means better performance as a phase transfer material (e.g. higher thermal energy storing ability). As such, in some embodiments of the invention, the composition has a latent heat of fusion of from 100 to 400 J/g, such as from 180 to 300 J/g, such as 291 J/g. The latent heat of fusion (i.e. the latent heat of transition from solid to liquid) may be measured by differential scanning calorimetry (DSC). The latent heat of fusion may be replaced by the phrase “enthalpy of phase transition”.

For the avoidance of doubt, it is explicitly contemplated that where a number of numerical ranges related to the same feature are cited herein, that the end points for each range are intended to be combined in any order to provide further contemplated (and implicitly disclosed) ranges.

Thus, taking the numerical ranges immediately above as an example, there is disclosed a phase change composition having a latent heat of fusion of:
from 100 to 180 J/g, from 100 to 291 J/g, from 100 to 300 J/g, from 100 to 400 J/g;
from 180 to 291 J/g, from 180 to 300 J/g, from 180 to 400 J/g;
from 291 to 300 J/g; from 291 to 400 J/g; and
from 300 to 400 J/g.

In some embodiments of the invention, the composition comprises a further component selected from a nucleating agent, a thermal stabiliser, an anti-oxidant, a metal deactivator, a corrosion inhibitor, a fire-retardant, a structuring agent, a fatty acid, a thermal conductivity enhancer and mixtures thereof. In particular embodiments of the invention, the further component is selected from an anti-oxidant, a structuring agent, a flame retardant and mixtures thereof. The further component may be soluble in the PCM composition.

The nucleating agent may prevent sub-cooling of the PCM composition. The nucleating agent may be selected from a fatty acid, a fatty amide, a paraffin, a polyether and mixtures thereof. The nucleating agent may be a wax. The nucleating agent may be selected from squalane wax, behenyl behenate, stearic acid, lauric acid, myristic acid, palmitic acid, behenic acid, stearamide, beeswax, montane wax, dicalite, graphite, fumed silica, precipitated silica, potassium dihydrogen phosphate, calcium sulfate and mixtures thereof.

The thermal stabiliser may prevent or retard thermally induced decomposition or isomerization of the PCM composition. The thermal stabilizer may prevent or retard formation of lower molecular weight products or isomers resulting from thermally induced decomposition or isomerization of the fatty alcohol. The thermal stabiliser may be selected from cadmium salts, lead salts, aluminum salts, titanium salts, antimony salts, tin salts, phosphites, phosphonites, phosphate esters and mixtures thereof.

The antioxidant may prevent or retard oxidation of the PCM composition. In particular, an antioxidant may prevent or retard formation of products resulting from reaction of the fatty alcohol with atmospheric oxygen or with oxygen free radicals. The anti-oxidant may be any suitable known antioxidant. For example, the anti-oxidant may be selected from butylated hydroxytoluene (BHT), phenolic antioxidants, sterically hindered phenolic antioxidants, thioether antioxidants, aromatic amines and mixtures thereof.

The metal deactivator may form an inactive complex with a catalytically active metal ion which may be present in the composition. Thus, complexation of the metal with the metal deactivator prevents metals from associating with hydro-peroxides, i.e., it decreases its ability to produce radicals from hydroperoxides by oxidation or reduction. The metal deactivator may be any chelating agents well suited for this purpose. The metal deactivator may be selected from oxyalyl bis(benzylidene)hydrazine, citric acid, N,N′-(disalicylidene)-1,2-propanediamine, ethylene-diaminetetraacetic acid (EDTA) derivatives, mercaptobenzothiazoles, mercaptobenzimidazoles, thiadiazole and triazole derivatives. Examples of EDTA derivatives are described in U.S. Pat. No. 3,497,535.

The corrosion inhibitor may decrease the corrosion rate of a material, typically a metal or an alloy that comes into contact with it. The corrosion inhibitor may be selected from any suitable agent.

The fire retardant may be required for fire safety purposes or to conform with fire safety regulations for some uses of the PCM composition. The fire retardant may be selected from a halogenated hydrocarbon, a phosphate ester, antimony oxide and mixtures thereof. The fire retardant may be selected from chloroparaffin, bromooctadecane, bromopentadecane, bromononadecane, bromoeicosane, bromodocosane, bis(pentabromophenyl) oxide, bis(tetrabromophenyl) oxide, tri(2-chloroethyl)phosphate (TCEP), tri(2-chloroisopropyl)phosphate (TCPP) and mixtures thereof.

The structuring agent may help in the containment of the PCM composition. The PCM composition may change from solid to liquid and vice versa many times during use, and the structuring agent may add structure to the liquid PCM so that it is easier to contain. The structuring agent may be selected from structuring polymers, gelling polymers, thixotropic polymers and mixtures thereof. The structuring agent may be selected from polyamides, polyurethanes, polyethers, polyacrylates and copolymers and mixtures thereof.

As mentioned below, the fatty alcohol may be obtained from natural sources. In such embodiments, fatty acid(s) may be present in small quantities along with the fatty alcohol. As such in some embodiments of the invention, the fatty acid may be present.

The thermal conductivity enhancer may improve the thermal conductivity of the PCM composition. Any suitable metal powder, metal colloid or filler may be used. The thermal conductivity enhancer may be selected from aluminum powder, graphene, graphite, boron nitride and nanoparticles thereof.

In some embodiments of the invention, the further component is present in an amount of from 0.01 to 10 wt % (e.g. from 0.1 to 5 wt %).

The chemicals described herein (e.g. fatty alcohols) may be obtained from natural and/or petrochemical sources. Such chemicals typically include a mixture of chemical species. Due to the presence of such mixtures, the parameters defined herein may be an average value and may be non-integral.

The compounds may be referred to herein by their systematic names (e.g. 1-docosanol) or by their equivalent trivial or commercial names (e.g. behenyl alcohol).

In a second aspect of the invention, there is provided a phase change material product comprising a container and a phase change material composition as described above housed within the container.

The container may be made of any suitable material. A suitable material is a metal. In particular embodiments, the container may be made of a metal selected from steel, aluminium, titanium, magnesium and alloys thereof.

In alternative embodiments, if the operating temperature of the phase change material product is below 40° C., the container may be made of a plastic. The container may be made of a plastic selected from polyamides, polyamines, polyimides, polyacrylics, polycarbonates, polydienes, polyepoxides, polyesters, polyethers, polyfluorocarbons, formaldehyde polymers, natural polymers, polyolefins, fluorinated polyolefins, polyphenylenes, silicon containing polymers, polyurethanes, polyvinyls, polyacetals, polyacrylates and copolymers and mixtures thereof. In particular embodiments, the container may be made of a plastic selected from high density polyethylene and polypropylene.

The container may be rigid or flexible. The container may be a tube, a rod, a pouch or a panel, such as a pouch or a panel.

In some embodiments, it may be useful to protect the PCM composition from air and water. The container may be sealed (e.g. hermetically sealed) for this purpose.

The product may further comprise a heat exchanger. The heat exchanger may allow exchange of thermal energy between the PCM composition and the environment. The heat exchanger may be made of any suitable material for this purpose. For example, the heat exchanger may be made of a metal selected from steel, aluminum, titanium, magnesium, copper and alloys thereof. In some embodiments, the heat exchanger is a plate heat exchanger or a spiral heat exchanger.

In some embodiments, there is provided a product or system comprising the phase change material product as described above. In some embodiments, the product or system is selected from a textile, a foam, a medical device, an electronic product, a packaging material, a construction material, a refrigeration system, a water heating system, and a heating, ventilation, air-conditioning (HVAC) system, optionally wherein the product or system is a water heating system (e.g. a domestic water heating system) or a heating, ventilation, air-conditioning (HVAC) system.

The phase change composition as described herein absorb or release thermal energy. As such, in a third aspect of the invention, there is disclosed a method of regulating temperature in an environment comprising the steps of:
(a) providing in the environment an amount of a phase change material composition as described above; and
(b) storing and releasing thermal energy in the phase change material composition by transfer of thermal energy between the environment and the phase change material composition, such that the temperature of the environment is regulated over a period of time.

Any suitable amount of a phase change material composition may be used in the method, depending on the application. For example, the phase change material composition may be provided in an amount of from 0.01 g to 100 kg (e.g. 20 kg).

In some embodiments of the invention, the transfer of thermal energy between the environment and the phase change material composition is used in the temperature regulation of sanitary water and/or in heating, ventilation and air-conditioning (HVAC) systems

The method allows the temperature of the environment to be regulated over a period of time. In some embodiments of the invention, the period of time is from 1 minute to 7 days, such as from 5 minutes to 3 days, such as from 10 minutes to 1 hour (e.g. 20 minutes).

In some embodiments of the invention, the transfer of thermal energy between the environment and the phase change material composition is used in the temperature regulation of a heat or cold sensitive material located within the environment. In some embodiments of the invention, the heat or cold sensitive material is selected from a fluid and a solid. In particular embodiments of the invention, the heat or cold sensitive material is water (e.g. sanitary water).

In a fourth aspect of the invention, there is provided the use of a fatty alcohol that has from 10 and 30 carbon atoms as a temperature regulating media for sanitary water and/or for heating, ventilation and air conditioning (HVAC) systems. The fatty alcohol (e.g. 1-docosanol) may be incorporated in a phase change material composition as described above.

The phase change composition may comprise a linear saturated fatty alcohol, which has from 10 to 26 carbon atoms. As such, the phase change material compositions and products of the invention combines the following advantages of conventional paraffin and non-paraffin-based phase change compositions
High purity grades (i.e. >98% pure) fatty alcohols are generally cheaper than organic PCMs;
They show good compatibility with materials commonly used in systems incorporating phase change materials; and
They may be produced from renewable sources.

In particular, the phase change material compositions and products of the invention have the following advantages over other organic PCMs.
They are safer materials, due to their higher flash point compared to linear paraffins with the same number of carbon atoms.
They are relatively stable to oxidizing agents;
They have higher enthalpy or latent heat of fusion and as such, improved thermal storage ability, compared to other organic PCMs (e.g. saturated linear fatty acids) with the same number of carbon atoms; and
They cover a wide range of melting temperatures (e.g. from 6 to 85° C.) that are useful for various applications, such as HVAC systems and domestic water heating.

Any or all of the disclosed features, and/or any or all of the steps of any method described herein, may be used in any aspect of the invention.

Further details of the invention will now be described with reference to the following non-limiting examples.

### EXAMPLES

### Materials and Methods

The materials were purchased from the sources as provided below.
1-decanol (CAS 112-30-1, 98% purity, liquid)
1-dodecanol (CAS 112-53-8, 99% purity, solid)
1-tridecanol (CAS 112-70-9, 97% purity, solid)
1-tetradecanol (CAS 112-72-1, 97% purity, solid)
1-pentadecanol (CAS 629-76-5, 99% purity, solid)
1-hexadecanol (CAS 36653-82-4, 98% purity, solid)
1-octadecanol (CAS 112-92-5, 98% purity, solid)
1-docosanol (CAS 661-19-8, 98% purity, solid)

All test procedures and physical parameters described herein have been determined at atmospheric pressure, unless otherwise stated herein, or unless otherwise stated in the referenced test methods and procedures. All parts and percentages are given by weight unless otherwise stated.

### General Procedure 1: Differential Scanning Calorimetry Analysis of Fatty Alcohols

Differential Scanning calorimetry (DSC) was performed using a TA Instruments Q2000 under a flow of nitrogen gas at a rate of 5 K/min in hermetically sealed aluminum pans. 6 to 10 mg of a sample and a heating rate of 5° C./min was used. The fatty alcohols were used as received in this test. The collected data were analyzed by the “Universal Analysis 2000” software”.

The DSC data for the materials are presented in Table 1.

TABLE 1

| | | Melting | Latent heat | Crystallization |
|---|---|---|---|---|
| | Total | point | of fusion | temperature |
| Samples | Carbon atoms | [° C.] | [J/g] | [° C.] |
| 1-decanol | 10 | 6 | 192.7 | 1 |
| 1-dodecanol | 12 | 24 | 191.9 | 20 |
| 1-tridecanol | 13 | 31 | 229.1 | 29 |
| 1-tetradecanol | 14 | 37 | 250 | 35 |
| 1-pentadecanol | 15 | 42 | 252.7 | 42 |
| 1-hexadecanol | 16 | 46 | 250 | 46 |
| 1-octadecanol | 18 | 57 | 260 | 56 |
| 1-docosanol | 22 | 70 | 291 | 69 |

Table 2 compares the latent heat of fusion of the linear fatty alcohols with available data (International Journal of Green Energy, Volume 1, 2005—Issue 4) for fatty acids with the same number of carbon atoms.

TABLE 2

| | Fatty acids | Fatty alcohols |
|---|---|---|
| Number of | heat of fusion | heat of fusion |
| carbon atoms | [J/g] | [J/g] |
| 14 | 197 | 250 |
| 16 | 212 | 250 |

Table 3 compares the latent heat of fusion of the linear fatty alcohols with available data (Energy Sources, Volume 16, 1994-Issue 1) for linear alkanes with the same number of carbon atoms.

TABLE 3

| | Linear alkanes | Fatty alcohols |
|---|---|---|
| Number of | heat of fusion | heat of fusion |
| carbon atoms | [J/g] | [J/g] |
| 14 | 227 | 250 |
| 16 | 236 | 250 |
| 18 | 244 | 260 |
| 22 | 252 | 291 |

As evident from Tables 2 and 3, linear fatty alcohols consistently have a higher latent heat of fusion compared to alkanes or fatty acids having the same number of carbon atoms.

### Example 1: Laboratory-Scale Evaluation of Docosanol for Use as PCM

Tests were conducted to compare the performance of docosanol with a commercial PCM (a comparative example). The comparative PCM is a bio-PCM ester having a similar melting point of 70° C. Information about the ester structure is not available.

### DSC Data

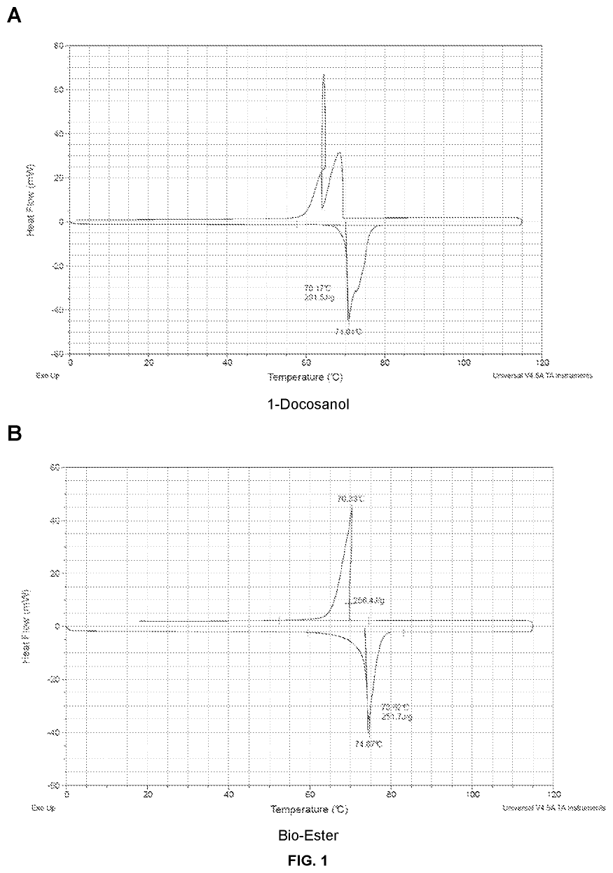

The test was conducted according to General Procedure 1. FIG. 1 shows that compared to the commercial PCM, docosanol provides 16% higher latent heat. 1-Docosanol also maintains a stable starting phase change temperature of around 70° C. when heated or cooled, indicating the absence of or negligible supercooling.

1. A phase change material composition comprising a fatty alcohol, which has from 10 to 30 carbon atoms, that is able to store and to release thermal energy.

2. The composition according to claim 1, wherein the fatty alcohol is a saturated linear fatty alcohol having 10 to 26 carbon atoms, such as from 16 to 26 carbon atoms (such as from 20 to 24 carbon atoms, such as 22 carbon atoms).

3. The composition according to claim 2, wherein the fatty alcohol is selected from one or more of the group consisting of 1-decanol, 1-dodecanol, 1-tridecanol, 1-tetradecanol, 1-pentadecanol, 1-hexadecanol, 1-octadecanol and 1-docosanol (e.g. the saturated linear fatty alcohol is selected from one or more of the group consisting of 1-hexdecanol, 1-octadecanol and 1-docosanol).

4. The composition according to claim 3, wherein the fatty alcohol is 1-docosanol.

5. The composition according to any one of the preceding claims, wherein the composition has a melting point of from 4 to 85° C. such as from 5 to 80° C., such as from 6 to 75° C., such as 70° C.

6. The composition according to any one of the preceding claims, wherein the composition has a latent heat of fusion of from 100 to 400 J/g such as from 180 to 300 J/g, such as 291 J/g.

7. The composition according to any one of the preceding claims, wherein the composition comprises a further component selected from a nucleating agent, a thermal stabiliser, an anti-oxidant, a metal deactivator, a corrosion inhibitor, a fire-retardant, a structuring agent, a fatty acid, a thermal conductivity enhancer and mixtures thereof.

8. The composition according to claim 7, wherein the further component is selected from an anti-oxidant, a structuring agent, a flame retardant and mixtures thereof.

9. The composition according to any one of claims 7 to 8, wherein the further component is present in an amount of from 0.01 to 10 wt % (e.g. from 0.1 to 5 wt %).

10. A phase change material product comprising a container and a phase change material composition according to any one of claims 1 to 10 housed within the container.

11. The product according to claim 10, wherein the product further comprises a heat exchanger.

12. The product according to claim 11, wherein the heat exchanger is a plate heat exchanger or a spiral heat exchanger.

13. A product or system comprising the phase change material product according to any one of claims 10 to 12, optionally wherein the product or system is selected from a textile, a foam, a medical device, an electronic product, a packaging material, a construction material, a refrigeration system, a water heating system, and a heating, ventilation, air-conditioning (HVAC) system, optionally wherein the product or system is a water heating system (e.g. a domestic water heating system) or a heating, ventilation, air-conditioning (HVAC) system.

14. A method of regulating temperature in an environment comprising the steps of:
(a) providing in the environment an amount of a phase change material composition according to any one of claims 1 to 9; and
(b) storing and releasing thermal energy in the phase change material composition by transfer of thermal energy between the environment and the phase change material composition, such that the temperature of the environment is regulated over a period of time.

15. The method according to claim 14, wherein the transfer of thermal energy between the environment and the phase change material composition is used in the temperature regulation of sanitary water and/or in heating, ventilation and air-conditioning (HVAC) systems.

16. The method according to any one of claims 14 to 15, wherein the period of time is from 1 minute to 7 days, such as from 5 minutes to 3 days, such as from 10 minutes to 1 hour (e.g. 20 minutes).

17. The method according to any one of claims 14 to 16, wherein the transfer of thermal energy between the environment and the phase change material composition is used in the temperature regulation of a heat or cold sensitive material located within the environment.

18. The method according to claim 17, wherein the heat or cold sensitive material is water.

19. Use of a fatty alcohol that has from 10 and 30 carbon atoms as a temperature regulating media for sanitary water and/or for heating, ventilation and air conditioning (HVAC) systems.
